(19) United States
(12) Patent Application Publication
(10) Pub. No.: US 2011/0187757 A1
(43) Pub. Date: Aug. 4, 2011

(54) SOURCE DRIVING APPARATUS FOR DISPLAY

(75) Inventors: Jung-Ping Yang, Hsinchu County (TW); Chien-Yu Chen, Hsinchu County (TW); Yu-Kuang Chang, Nantou County (TW); Hsi-Ming Chen, Hsinchu City (TW)

(73) Assignee: NOVATEK MICROELECTRONICS CORP., Hsinchu (TW)

(21) Appl. No.: 13/012,810

(22) Filed: Jan. 25, 2011

(30) Foreign Application Priority Data
Jan. 29, 2010 (TW) 99102676

(51) Int. Cl. G09G 5/10

(52) U.S. Cl. 345/690

(57) ABSTRACT

A source driving apparatus of a display is disclosed. The source driving apparatus includes a digital-to-analog converter, a selecting signal generator and a voltage selector. The digital-to-analog converter receives a first part display signal of a display signal and a plurality of gamma voltages and selects a first selecting gamma voltage and a second selecting gamma voltage within the gamma voltages according to the first part display signal. The selecting signal generator receives a second part display signal of the display signal expect the first part display signal and a plurality of pulse-width-modulation (PWM) signals. The selecting signal generator selects one of the PWM signals to generate a selecting signal according to the second part display signal. The voltage selector outputs the first selecting gamma voltage or the second selecting gamma voltage according to a pulse width of the selecting signal.

### CROSS-REFERENCE TO RELATED APPLICATION

This application claims the priority benefit of Taiwan application serial no. 99102676, filed on Jan. 29, 2010. The entirety of the above-mentioned patent application is hereby incorporated by reference herein and made a part of this specification.

### BACKGROUND OF THE INVENTION

1. Field of the Invention

The present invention relates to a source driving apparatus for a display.

2. Description of Related Art

Referring to FIG. 1, FIG. 1 is a schematic diagram illustrating a conventional source driving apparatus of a display. The source driving apparatus 110 is used to drive a display panel 120. The source driving apparatus 110 includes a gamma voltage generator 111, a digital-to-analog converter (DAC) 112 and an output buffer formed by an operational amplifier OP1. The gamma voltage generator 111 generates a plurality of gamma voltages to the DAC 112. The DAC 112 further receives a display signal DATA representing a desired image data, and selects most suitable one of the gamma voltages for outputting to the operational amplifier OP1 according to the display signal DATA. The operational amplifier OP1 is connected as a voltage follower to serve as the output buffer, and generates an output voltage Voutput to drive the display panel 120.

The display panel 120 (for example, a liquid crystal display panel) can be equivalent to a circuit formed by a resistor Rp and a capacitor Cp. Namely, the conventional source driving apparatus 110 directly provides the output voltage Voutput to the display panel 120. On the other hand, to ensure all of the display signals DATA having the corresponding gamma voltages to serve as the output of the DAC 112, the gamma voltage generator 111 is required to generate enough gamma voltages. Taking the display signal DATA of 8 bits as an example, the gamma voltage generator 111 is required to generate 256 gamma voltages.

### SUMMARY OF THE INVENTION

The present invention is directed to a source driving apparatus of a display, which can provide gamma voltages to drive different display panels according to different modulation frequencies.

The present invention provides a source driving apparatus of a display. The source driving apparatus includes a digital-to-analog converter (DAC), a selecting signal generator and a voltage selector. The DAC receives a first part display signal of a display signal and a plurality of gamma voltages and selects to output a first selecting gamma voltage and a second selecting gamma voltage within the gamma voltages according to the first part display signal. The selecting signal generator receives a second part display signal of the display signal expect the first part display signal and a plurality of pulse-width-modulation (PWM) signals. The selecting signal generator selects one of the PWM signals to generate a selecting signal according to the second part display signal. The voltage selector is coupled to the selecting signal generator and the DAC, and outputs the first selecting gamma voltage or the second selecting gamma voltage according to a pulse width of the selecting signal.

In an embodiment of the present invention, the display signal has N bits, the first part display signal has M bits, and the second part display signal has N-M bits, wherein N and M are positive integers and N is greater than M.

In an embodiment of the present invention, the voltage selector selects to output the second selecting gamma voltage when the selecting signal has a high voltage level, and selects to output the first selecting gamma voltage when the selecting signal has a low voltage level, wherein the first selecting gamma voltage is smaller than the second selecting gamma voltage.

In an embodiment of the present invention, the source driving apparatus further includes a gamma voltage generator, and the gamma voltage generator is coupled to the DAC for providing the gamma voltages.

In an embodiment of the present invention, the source driving apparatus further includes a selecting signal shielding device. The selecting signal shielding device is coupled between the selecting signal generator and the voltage selector, and receives a shielding signal. The selecting signal shielding device enables the voltage selector to fixedly output one of the first selecting gamma voltage and the second selecting gamma voltage according to the shielding signal.

In an embodiment of the present invention, the selecting signal shielding device is an AND gate. An input terminal of the AND gate is coupled to the selecting signal generator, another input terminal of the AND gate receives the shielding signal, and an output terminal of the AND gate is coupled to the voltage selector.

In an embodiment of the present invention, the source driving apparatus further includes an output buffer module. The output buffer module is coupled to the voltage selector, and receives an output of the voltage selector to generate an output voltage.

In an embodiment of the present invention, the output buffer module is a voltage follower.

In an embodiment of the present invention, the output buffer module includes a first chopper, a first operational amplifier, a bias voltage source, a second chopper and a second operational amplifier. An input terminal of the first chopper receives the output of the voltage selector, and another input terminal receives the output signal. An input terminal of the first operational amplifier is coupled to an output terminal of the first chopper. The bias voltage source is coupled between the first chopper and the first operational amplifier. An input terminal of the second chopper is coupled to an output terminal of the first operational amplifier. An input terminal of the second operational amplifier is coupled to an output terminal of the second chopper, and an output terminal thereof outputs the output signal.

According to the above descriptions, in the present invention, the selecting signal generator outputs PWM signals of different frequencies according to the second part display signal, so as to modulate a frequency suitable for the display panel to be driven by the source driving apparatus. Moreover, an interpolation effect is achieved according PWM signals of different pulse widths.

In order to make the aforementioned and other features and advantages of the present invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating a conventional source driving apparatus of a display.

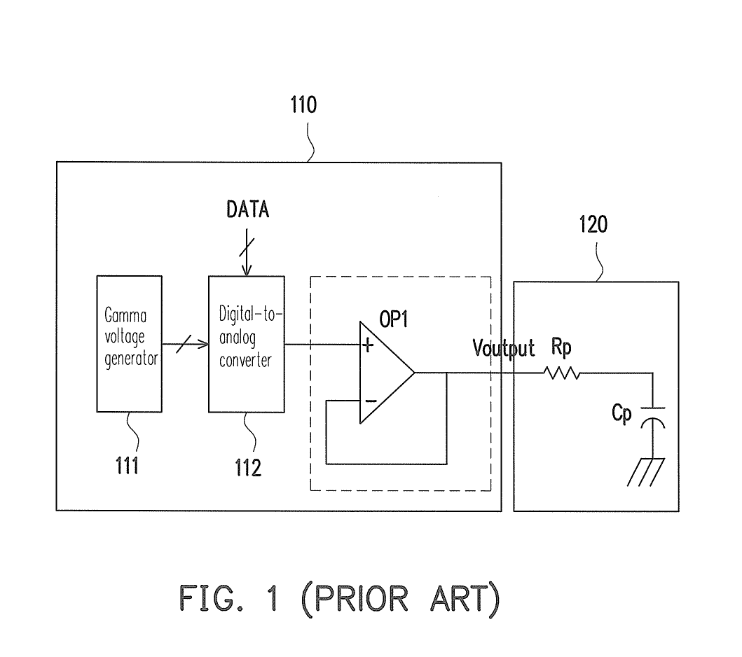

FIG. 2 is a schematic diagram illustrating a source driving apparatus 200 according to an embodiment of the present invention.

FIG. 3 is a diagram illustrating output waveforms of a voltage selector 240.

FIG. 4 is a diagram illustrating signal waveforms of a source driving apparatus 200 used for driving a display panel 290.

FIG. 5 is a schematic diagram illustrating a source driving apparatus 500 according to another embodiment of the present invention.

### DESCRIPTION OF THE EMBODIMENTS

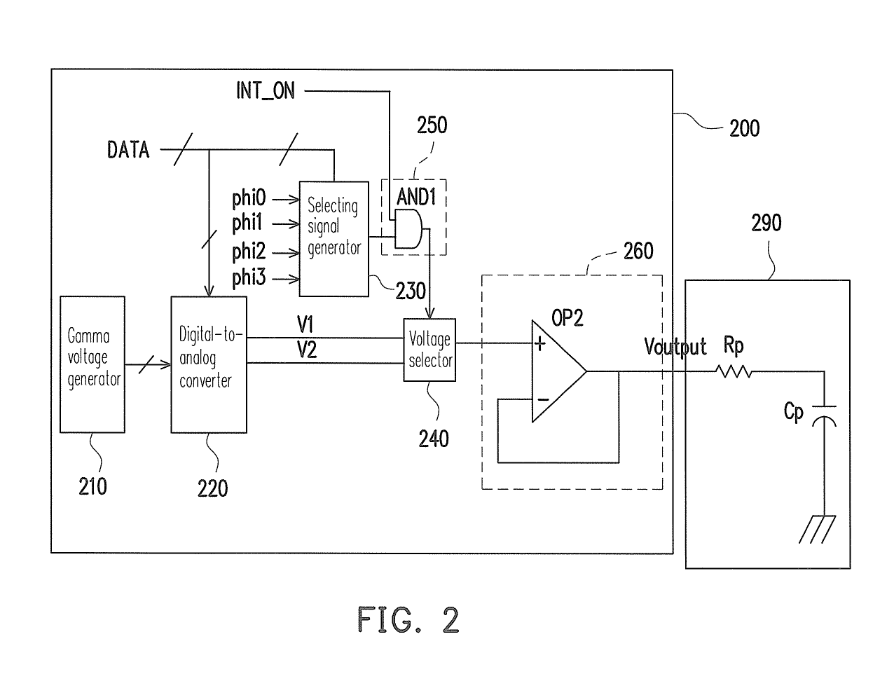

Referring to FIG. 2, FIG. 2 is a schematic diagram illustrating a source driving apparatus 200 according to an embodiment of the present invention. The source driving apparatus 200 is used for driving a display panel 290. The source driving apparatus 200 includes a gamma voltage generator 210, a digital-to-analog converter (DAC) 220, a selecting signal generator 230, a voltage selector 240, a selecting signal shielding device 250 and an output buffer module 260. The display panel 290 is equivalent to a circuit formed by a resistor Rp and a capacitor Cp. The gamma voltage generator 210 is used to generate a plurality of gamma voltages, and the DAC 220 receives the gamma voltages. Moreover, in the present embodiment, a display signal DATA is split into two part display signals, wherein one part display signal is transmitted to the DAC 220. The DAC 220 selects and outputs two of the gamma voltages to serve as a first selecting gamma voltage V1 and a second selecting gamma voltage V2 according to the received part display signal. The display signal DATA has N bits of digital data, and the part display signal transmitted to the DAC 220 has M bits of digital data, wherein M and N are all positive integers, and N>M.

For example, if the display signal DATA is consisted of 8 bits from a 7th bit to a 0th bit, and the part display data transmitted to the DAC 220 is the 7th bit to the 2nd bit (total 6 bits) in the display signal DATA, the gamma voltage generator 210 is required to generate 2⁶ (i.e. 64) gamma voltages.

Moreover, a method for the DAC 220 selecting the first selecting gamma voltage V1 and the second gamma voltage V2 is described as follows with reference of the above example. If the part display signal transmitted to the DAC 220 is “101010” (arranged from a high bit to a low bit), the DAC 220 selects a gamma voltage corresponding to “10101000” to serve as the first selecting gamma voltage V1, and selects a gamma voltage corresponding to “10101011” to serve as the second selecting gamma voltage (V2−V1)*0.75+V1.

Another part display signal of the display signal DATA is transmitted to the selecting signal generator 230. The selecting signal generator 230 further receives a plurality of pulse-width-modulation (PWM) signals phi0, phi1, phi2 and phi3. Pulse widths of the PWM signals phi0, phi1, phi2 and phi3 are different. Assuming the other part display signal has two bits, the selecting signal generator 230 selects to output one of the four PWM signals phi0-phi3 to serve as a selecting signal according to the part display signal with two bits.

The voltage selector 240 is coupled to the selecting signal generator 230 and the DAC 220. The voltage selector 240 receives the selecting signal generated by the selecting signal generator 230 and the first selecting gamma voltage V1 and the second selecting gamma voltage V2 generated by the DAC 220. The selecting signal is a PWM signal, and it is known by those skilled in the art that the PWM signal is consisted of a high level voltage and a low level voltage. Therefore, the voltage selector 240 outputs the first selecting gamma voltage V1 or the second selecting gamma voltage V2 according to a high level or a low level of the selecting signal.

For example, if a duty cycle of the PWM signal phi3 is 75%, a duty cycle of the PWM signal phi2 is 50%, a duty cycle of the PWM signal phi1 is 25%, and a duty cycle of the PWM signal phi0 is 0%, and if the selecting signal received by the voltage selector 240 is the PWM signal phi3, 75% of the output of the voltage selector 240 is maintained to the higher second selecting gamma voltage V2, and 25% of the output of the voltage selector 240 is maintained to the lower first selecting gamma voltage V1. In view of an average voltage, the average voltage of the output of the voltage selector 240 can be represented by Vavg=V1+(V2−V1)*75%. In other words, if the selecting signal received by the voltage selector 240 is the PWM signal phi1, 25% of the output of the voltage selector 240 is maintained to the second selecting gamma voltage V2, and 75% of the output of the voltage selector 240 is maintained to the first selecting gamma voltage V1. In this case, the average voltage of the output of the voltage selector 240 can be represented by Vavg=V1+(V2−V1)*25%.

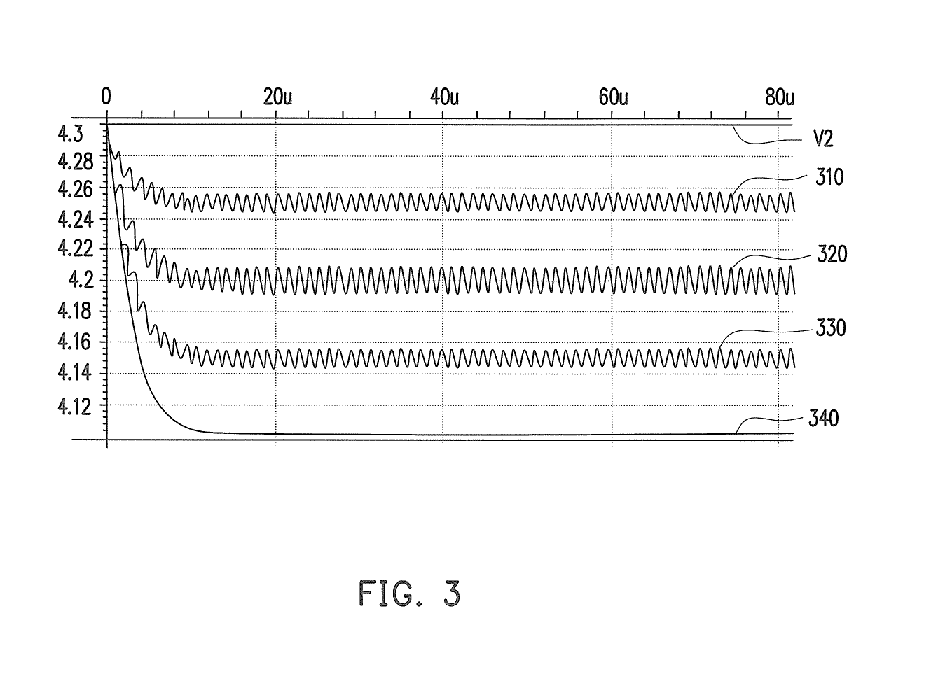

FIG. 3 is a diagram illustrating output waveforms of the voltage selector 240. Waveforms 310, 320, 330 and 340 are the output waveforms of the voltage selector 240 when the selecting signal received by the voltage selector 240 is respectively the PWM signals phi3, phi2, phi1 and phi0, wherein the first selecting gamma voltage V1 is 4.1 volts (V), and the second selecting gamma voltage V2 is 4.3V. It should be noticed that when the waveform 340 is stable, it is fixed to be equal to the first selecting gamma voltage V1, and is not switched between the first and the second selecting gamma voltages V1 and V2.

Referring to FIG. 2 again, the selecting signal shielding device 250 is coupled between the selecting signal generator 230 and the voltage selector 240. As shown in FIG. 2, the selecting signal shielding device 250 is implemented by an AND gate AND1. An input terminal of the AND gate AND1 receives a shielding signal INT_ON, another input terminal thereof receives the selecting signal output by the selecting signal generator 230, and an output terminal of the AND gate AND1 is coupled to the voltage selector 240. When the shielding signal INT_ON is at a logic low level, a path that the selecting signal is transmitted to the voltage selector 240 through the AND gate AND1 is shielded. Conversely, when the shielding signal INT_ON is at a logic high level, the selecting signal is transmitted to the voltage selector 240 through the AND gate AND1. The selecting signal shielding device 250 is mainly used to prevent the selecting signal from transmitting to the voltage selector 240 in advance before an output signal Voutput of the source driving apparatus 200 is raised to a stable voltage, so as to avoid influencing a response time of the output signal Voutput.

It should be noticed that it is only an example for implementing the selecting signal shielding device 250 by the AND gate AND1, and those skilled in the art should understand that the same function probably corresponds to various logic circuit implementations, and logic gates such as an OR gate, an NAND gate or an NOR gate can also be used to implement the selecting signal shielding device 250.

The output buffer module 260 is coupled to the voltage selector 240, and is used for receiving the output of the voltage selector 240 to generate the output signal Voutput. In the present embodiment, the output buffer module 260 is implemented by coupling an operational amplifier OP2 as a voltage follower. Namely, one input terminal of the operational amplifier OP2 receives the output of the voltage selector 240, and another input terminal of the operational amplifier OP2 is coupled to an output terminal thereof, and the output terminal outputs the output signal Voutput.

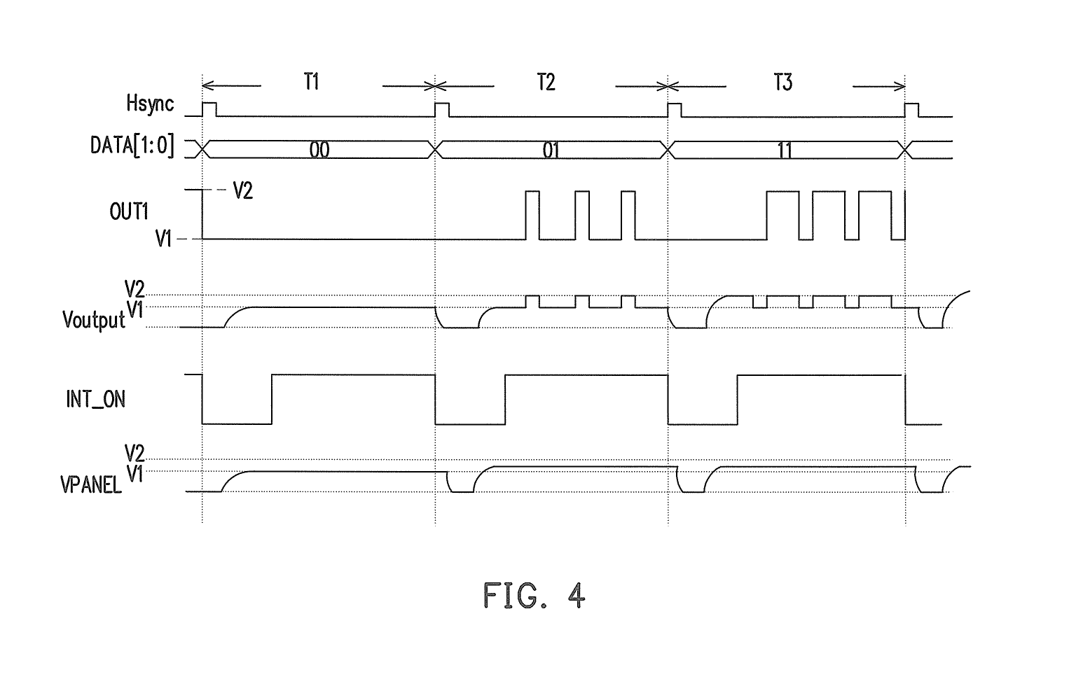

FIG. 4 is a diagram illustrating signal waveforms of the source driving apparatus 200 used for driving the display panel 290. Referring to FIG. 2 and FIG. 4, during a duty cycle T1, when the source driving apparatus 200 detects that a vertical synchronization signal Hsync is enabled, the selecting signal generator 230 selects to output the PWM signal phi0 according to the 0th bit and the 1st bit of the display data DATA (DATA[1:0]=“00”), and the DAC 220 selects to output the first and the second selecting gamma voltages V1 and V2 according to the 7th bit to 2nd bit of the display data DATA. Before the output signal Voutput is raised to the first selecting gamma voltage V1, the shielding signal INT_ON is set to a logic low level. When the output signal Voutput is raised to the first selecting gamma voltage V1, the shielding signal INT_ON is set to a logic high level, and now the selecting signal phi0 generated by the selecting signal generator 230 is transmitted to the voltage selector 240. In the present embodiment, since a pulse width of the high level selecting signal phi0 is 0, an output OUT1 of the voltage selector 240 is maintained to be the first selecting gamma voltage V1.

During a duty cycle T2, when the source driving apparatus 200 detects that the vertical synchronization signal Hsync is enabled, the selecting signal generator 230 selects to output the PWM signal phi1 according to the 0th bit and the 1st bit of the display data DATA (DATA[1:0]=“01”). Before the output signal Voutput is raised to the first selecting gamma voltage V1, the shielding signal INT_ON is set to the logic low level. When the output signal Voutput is raised to the first selecting gamma voltage V1, the shielding signal INT_ON is set to the logic high level, and now the selecting signal phi1 generated by the selecting signal generator 230 is transmitted to the voltage selector 240. In this way, the voltage selector 240 outputs the second selecting gamma voltage V2 when the selecting signal phi 1 has the high level, and outputs the first selecting gamma voltage V1 when the selecting signal phi0 has the high level.

Similar as above, during a duty cycle T3, the selecting signal generator selects to output the PWM signal phi3 according to the 0th bit and the 1st bit of the display data DATA (DATA[1:0]=“11”). The voltage selector 240 generates the output OUT1 maintained to the second selecting gamma voltage V2 for a longer time.

Moreover, a driving voltage VPANEL is a signal actually received by the display panel 290. Since the display panel 290 can be equivalent to a low pass filter, the output signal Voutput transmitted to the display panel 290 can generate the driving voltage VPANEL having a waveform more close to a required waveform used for driving the display panel 290.

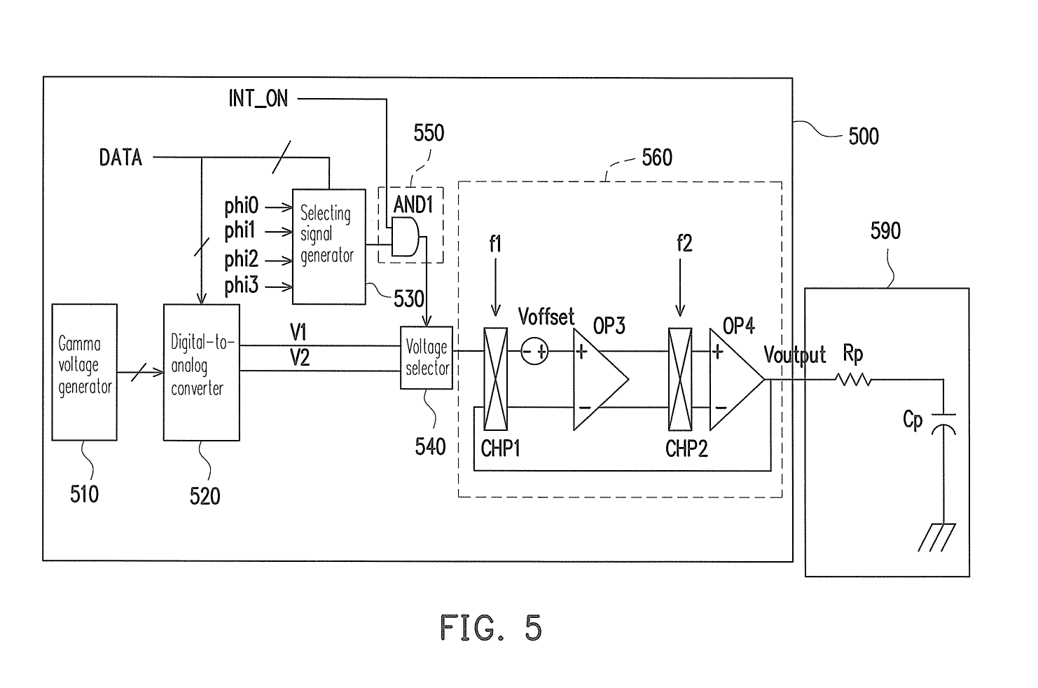

Referring to FIG. 5, FIG. 5 is a schematic diagram illustrating a source driving apparatus 500 according to another embodiment of the present invention. The source driving apparatus 500 includes a gamma voltage generator 510, a DAC 520, a selecting signal generator 530, a voltage selector 540, a selecting signal shielding device 550 and an output buffer module 560, and the source driving apparatus 500 is used to drive a display panel 590. Different to the above embodiment, the output buffer module 560 of the present embodiment includes choppers CHP1 and CHP2, operational amplifiers OP3 and OP4, and a bias voltage source Voffset. An input terminal of the chopper CHP1 receives the output of the voltage selector 540, and another input terminal thereof receives the output signal Voutput fed back from the operational amplifier OP4. An input terminal of the operational amplifier OP3 is coupled to an output terminal of the chopper CHP1. The bias voltage source Voffset is coupled between the chopper CHP1 and the operational amplifier OP3. An input terminal of the chopper CHP2 is coupled to an output terminal of the operational amplifier OP3. An input terminal of the operational amplifier OP4 is coupled to an output terminal of the chopper CHP2, and an output terminal of the operational amplifier OP4 outputs the output signal Voutput. The choppers CHP1 and CHP2 respectively receive clock signals f1 and f2 to perform data switching of different frequencies. Here, the output buffer module 560 can effectively eliminate an offset voltage error of an input stage in the operational amplifiers OP3 and OP4 that is generated due to the fabrication process.

It should be noticed that regarding the PWM signals phi1-phi3 mentioned in the aforementioned embodiments of the present invention, besides the pulse widths thereof can be set according to the corresponding part display signal, frequencies thereof can also be set according to a capacitance and a resistance of the driven display panel. In brief, the frequencies of the PWM signals phi1-phi3 are required to be higher than a cut-off frequency of an equivalent load (formed by a capacitor and a resistor) of the display panel.

In summary, in the present invention, the display signal is split into a high bit and a low bit part display signals, and the gamma voltage is selected according to the high bit part display signal, and then the PWM signal is generated according to the low bit part display signal. In this way, a number of the gamma voltages required to be generated by the gamma voltage generator is reduced, so that a circuit area is saved. Moreover, a suitable driving voltage can be provided in collaboration with the equivalent circuit formed by the capacitor and the resistor of the display panel, so as to improve a display quality.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A source driving apparatus of a display, comprising:
a digital-to-analog converter (DAC), receiving a first part display signal of a display signal and a plurality of gamma voltages, and selecting to output a first selecting gamma voltage and a second selecting gamma voltage within the gamma voltages according to the first part display signal;
a selecting signal generator, receiving a second part display signal of the display signal expect the first part display signal and a plurality of pulse-width-modulation (PWM) signals, and selecting one of the PWM signals to generate a selecting signal according to the second part display signal; and
a voltage selector, coupled to the selecting signal generator and the DAC, and outputting the first selecting gamma voltage or the second selecting gamma voltage according to a pulse width of the selecting signal.

2. The source driving apparatus as claimed in claim 1, wherein the display signal has N bits, the first part display signal has M bits, and the second part display signal has N-M bits, wherein N and M are positive integers and N is greater than M.

3. The source driving apparatus as claimed in claim 1, wherein the voltage selector selects to output the second selecting gamma voltage when the selecting signal has a high voltage level, and selects to output the first selecting gamma voltage when the selecting signal has a low voltage level, wherein the first selecting gamma voltage is smaller than the second selecting gamma voltage.

4. The source driving apparatus as claimed in claim 1, further comprising:
a gamma voltage generator, coupled to the DAC, for providing the gamma voltages.

5. The source driving apparatus as claimed in claim 1, further comprising:
a selecting signal shielding device, coupled between the selecting signal generator and the voltage selector, and receiving a shielding signal, the selecting signal shielding device enabling the voltage selector to fixedly output one of the first selecting gamma voltage and the second selecting gamma voltage according to the shielding signal.

6. The source driving apparatus as claimed in claim 5, wherein the selecting signal shielding device is an AND gate, wherein an input terminal of the AND gate is coupled to the selecting signal generator, another input terminal of the AND gate receives the shielding signal, and an output terminal of the AND gate is coupled to the voltage selector.

7. The source driving apparatus as claimed in claim 1, further comprising:
an output buffer module, coupled to the voltage selector, and receiving an output of the voltage selector to generate an output voltage.

8. The source driving apparatus as claimed in claim 7, wherein the output buffer module is a voltage follower.

9. The source driving apparatus as claimed in claim 7, wherein the output buffer module comprises:
a first chopper, having an input terminal receiving the output of the voltage selector, and another input terminal receiving the output signal;
a first operational amplifier, having an input terminal coupled to an output terminal of the first chopper;
a bias voltage source, coupled between the first chopper and the first operational amplifier;
a second chopper, having an input terminal coupled to an output terminal of the first operational amplifier; and
a second operational amplifier, having an input terminal coupled to an output terminal of the second chopper, and an output terminal outputting the output signal.
